(19) United States
(12) Patent Application Publication
(10) Pub. No.: US 2023/0012975 A1
(43) Pub. Date: Jan. 19, 2023

(54) Constructive Arrangement Applied To Portable Water Dispenser For Domestic Animals

(71) Applicant: PRODUTOS VIDA MANSA LTDA, Patos de Minas (BR)

(72) Inventor: Luiz Antonio do Carmo Rocha, Patos de Minas (BR)

(21) Appl. No.: 17/721,612

(22) Filed: Apr. 15, 2022

(30) Foreign Application Priority Data
Jul. 17, 2021 (BR) 202021014042-4

(51) Int. Cl. A01K 7/00

(52) U.S. Cl. CPC A01K 7/00

(57) ABSTRACT

The present utility model belongs to the technology sector of equipment for animals and, more specifically, relates to a portable water dispenser for domestic animals. The water dispenser in question enables the use of common water bottles for supply, having a reduced size and further avoiding waste of water. The water dispenser comprises an outer bowl (1), which receives water originating from the main bowl (2) through a transition region (3). It is observed that the outer bowl (1) has a design that is similar to the common water bowls, making the animal feel more familiarized with the container. Moreover, the dispenser presents a flat lower surface (4), avoiding that the tutor needs to hold it for the animal to consume water.

### TECHNOLOGY FIELD

The present utility model belongs to the technology sector of equipment for animals and, more specifically, relates to a portable water dispenser for domestic animals. The water dispenser in question enables the use of common water bottles for supply, having a reduced size and further avoiding waste of water.

### STATE OF THE ART

Water dispensers for pets are already known in the state of the art. Different constructions and designs are applied, with different manners of providing fresh water for the animal. According to granted utility model patent BR 202015018225-8, which describes a water dispenser comprising two bowls, a main one and an outer one, wherein the water is inserted in the main bowl, which supplies the water to the outer bowl so that there is no waste, that is, it releases water only when the animal is drinking from the outer bowl, maintaining always the same level.

However, it is extremely common, particularly with dogs, to become dehydrated when taken for a walk or run. While the tutor may easily carry one or more water bottles for hydration, the animal may remain dehydrated until he returns from the outing or, in some cases, require that the tutor share his own water, which enables contaminations both for the tutor and the animal.

There exist products on the internet that solve this problem making a portable water dispenser available where the tutor must have a specific bottle with a distinct nozzle so that it is possible to release water in an upper bowl.

In another product available in the market, the tutor can use an ordinary bottle, in a device which opens and closes the bottle and, when open, releases water in the animal's direction. In both products, it is observed that there occurs waste of water, apart from ending by wetting the animal, since there is no precise control of the amount of water released for consumption.

### SUMMARY OF THE UTILITY MODEL

The water dispenser that is the object of the present patent, has the objective of presenting a portable water dispenser with a nozzle to insert common water bottles, which releases water according to the animal's consumption, without wasting water, in an outer bowl having a smaller size, avoiding wetting the animal.

In this way, the object solves the problems of the state of the art, presenting the improvement of avoiding waste of water and wetting the animal. Additionally, the portable water dispenser enables the tutor to insert the bottle and does not require holding the water dispenser for the animal's consumption.

### ADVANTAGES OF THE UTILITY MODEL

By means of the geometry of the construction applied to the portable water dispenser, it is possible for the tutor to transport the water dispenser easily, making the animal hydrate in a healthy manner, without wasting water or getting wet. This is achieved by means of a threaded nozzle, which presents a thread configuration that is similar to the bottle lids, enabling the fit through the thread of the bottle in the dispenser.

Moreover, the water dispenser comprises a channeled transport to the outer bowl, enabling the water to be conveyed in a safe and clean manner, avoiding waste, since the water is released according to the animal's consumption. Additionally, with this geometry, the water dispenser avoids the animal getting wet.

By presenting a main bowl for receiving water and a separate outer bowl interconnected by means of a transition region, the dispenser has a lower flat surface, enabling the tutor to position it on a flat surface, for the animal to consume the water, avoiding having to hold the portable water dispenser in positions that are non-ergonomic for the tutor.

Moreover, by presenting an inner container, the water dispenser enables the tutor to pour water directly in the main bowl, filling the container, which will make the water available in the outer bowl. Last, the portable water dispenser enables the animal to hydrate inside a vehicle, due to the geometry thereof, which prevents the dispenser from turning.

### DESCRIPTION OF THE DRAWINGS

In order for this utility model to be fully understood and placed in practice by a person skilled in the art, the same will now be described in a clear, precise and sufficient manner, based on the attached drawings, as listed below:

FIG. 1—perspective view of the water dispenser;

FIG. 2—top view of the water dispenser;

FIG. 3—sectional view of FIG. 2;

### DETAILED DESCRIPTION OF THE UTILITY MODEL

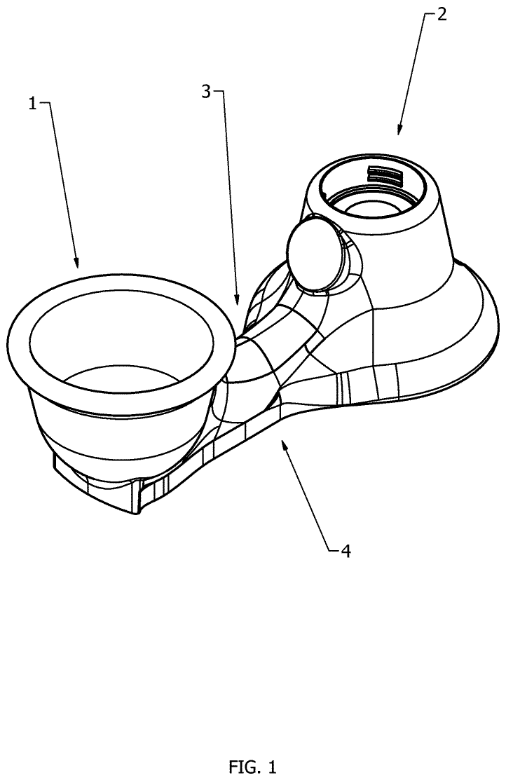

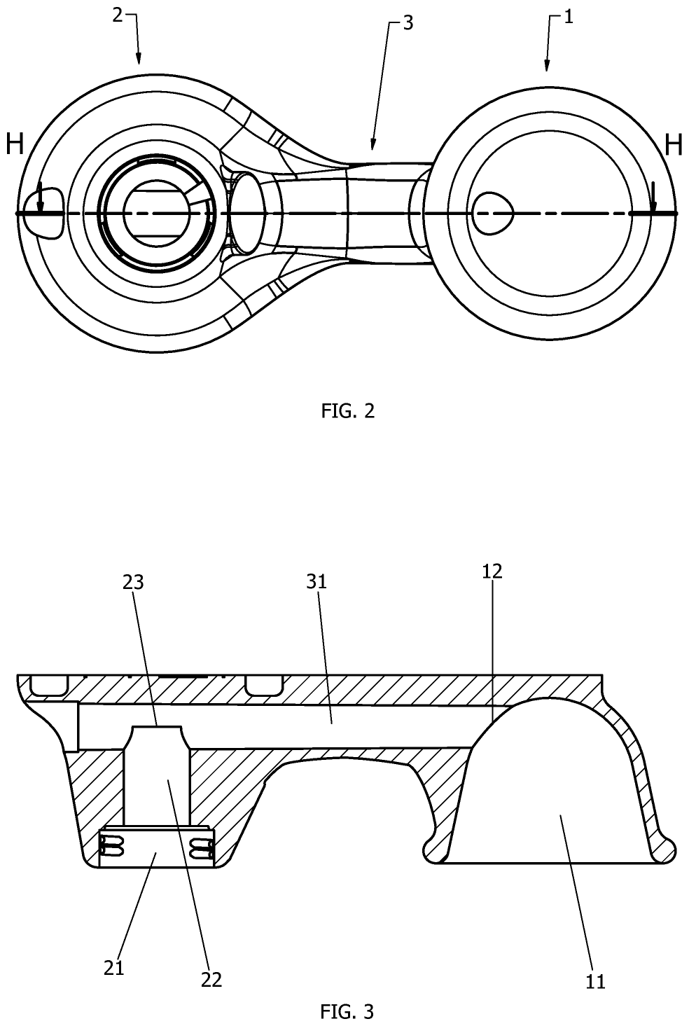

According to FIGS. 1 and 2, the water dispenser comprises an outer bowl (1), which receives water originating from the main bowl (2) through a transition region (3). It is observed that the outer bowl (1) has a design that is similar to the common water bowls, making the animal feel more familiarized with the container. Moreover, the water dispenser presents a flat lower surface (4), avoiding that the tutor needs to hold it for the animal to consume water.

According to FIG. 3, the main bowl (2) has a nozzle (21), with thread to fit a common bottle, and a reduction in diameter for a container (22) having a connection (23) with the channel (31) which conveys the water to the inner part (11) of the outer bowl (1) and deposits the water through the opening (12).

In an example of preferred embodiment, the tutor and the animal would be walking in a square, and, when sitting, the tutor would withdraw the portable water dispenser from a backpack or handbag, and fit a water bottle, for example of 500 ml, in the nozzle (21) of the main bowl (2), through the thread and position the dispenser on the floor for the animal to drink the available water from the outer bowl (1).

Last, the portable water dispenser in question presents a reduced size, the animal does not get wet. While the animal drinks the water, the water dispenser supplies the inner part (11) of the outer bowl (1), according to the animal's consumption.

The tutor may further remove the bottle from the nozzle (21) and wait for the animal to drink the water in the inner part of the water dispenser, present in the container (22) of the main bowl and in the channel (31) of the transition region.

At the end of the hydration of the animal, the tutor collects the portable water dispenser, already empty. In this way, the animal is hydrated, without wasting water.

Additionally, the portable water dispenser presented enables that, while the animal is hydrating, the tutor is free to rest and hydrate himself, without needing to hold the portable water dispenser for the animal. Optionally, the water dispenser enables the tutor to pour water directly in the container (22) of the main bowl (2), without using a bottle.

What is claimed is:

1. A portable water dispenser for domestic animals comprising an outer bowl and a main bowl constituted by a nozzle with thread characterized by the nozzle presenting a reduction in diameter for a container with connection to a channel, located in the transition region, which conveys the water to the inner part of the outer bowl and deposits the water through the opening, comprising a lower flat surface.
